(19) United States
(12) Patent Application Publication
(10) Pub. No.: US 2013/0304524 A1
(43) Pub. Date: Nov. 14, 2013

(54) SYSTEM AND METHOD FOR JOINTLY OPTIMIZING PRICING AND SEAT ALLOCATION

(71) Applicant: Massachusetts Institute of Technology, Cambridge, MA (US)

(72) Inventor: Claire Cizaire, Cambridge, MA (US)

(21) Appl. No.: 13/870,021

(22) Filed: Apr. 25, 2013

Related U.S. Application Data
(60) Provisional application No. 61/638,154, filed on Apr. 25, 2012.

(51) Int. Cl. G06Q 10/02

(52) U.S. Cl. CPC G06Q 10/02
USPC 705/5

(57) ABSTRACT

A system and method for jointly optimizing pricing and allocation contains a memory and a processor. The processor is configured by the memory to perform the steps of: analyzing raw data to detruncate a demand for bookings and to determine how a change in fares affects a volume of bookings; determining how booking limits censor the demand; determining revenues of all time frames for which seats are available; and determining fares and booking limits maximizing total revenues.

### CROSS-REFERENCE TO RELATED APPLICATION

This application claims priority to copending U.S. Provisional application entitled, “SYSTEM AND METHOD FOR JOINTLY OPTIMIZING PRICING AND SEAT ALLOCATION,” having Ser. No. 61/638,154, filed Apr. 25, 2012, which is entirely incorporated herein by reference.

### FIELD OF THE INVENTION

The present invention is generally related to automated optimization system, and more particularly is related to automated simultaneous optimization of pricing and inventory control.

### BACKGROUND OF THE INVENTION

Pricing and revenue management are two levers used to optimize the sales of seat inventory and maximize revenues for an airline. Pricing consists of the design of the different fare products that will be available to each origin-destination market served by the airline. The goal of pricing is to improve revenues. A fare product is a combination of a price, also called a fare, and an assortment of travel constraints and service amenities. Each fare product is designed for and targeted toward a specific group of travelers. Two well-known groups of travelers are business travelers and leisure travelers. By offering various fare products, the airline intends to force some passengers with travel constraints and a high willingness-to-pay to buy high revenue products, without deterring all other passengers from booking seats. The fare of the product is set according to the estimated willingness-to-pay of the segment's passengers. Different restrictions and service amenities are set and used as fences to deter passengers from buying fare products with a lower fare than their estimated willingness-to-pay.

An airline may offer a very large number of fare products by market. All these fare products constitute a fare structure. A new trend was initiated in 2007 with the emergence of the fare structure now called “Fare Families”. This new pricing strategy was implemented by several large airlines. An example of fair families is shown by FIG. 1. These airlines offer and brand a limited number of differentiated fare “families” (labeled as Fare Family 1 and Fair Family 2) with clearly defined restrictions and service amenities. These restrictions or characteristics can, for example, be: cancellation fee; refundable option; option to upgrade; percentage of accumulated miles; advance seat selection; and, access to a lounge at the airport. Within each fare family, however, there can be numerous price levels that can vary by time to departure.

Once the number of fare families is set, the bundle of restrictions and service amenities associated with each fare family determined, one thus has to decide on a price range for each fare family. A family with fewer restrictions is more attractive and should therefore have a higher price tag. For simplification purposes, in FIG. 1 notations are defined for a fare structure with two fare products, namely, fare Family 1 and Fare Family 2. Fare Family 1 represents the more expensive, less restricted family of products of the two fare families.

With this type of fare structure, passengers know the exact set of features associated to each fare family. The restrictions of the fare families remain the same throughout the entire booking period: they are constant characteristics of the fare families. The passengers are also free to pick their fare family based on their own perception of the trade-off between restrictions and fares.

Low cost carriers may choose to offer only one fare family by cabin. However, most large airlines will offer two or three fare families, giving passengers the freedom to choose between different alternatives. One could potentially offer more fare families. However, as the number of families grows, it becomes much harder to manage them efficiently. It is therefore recommended to limit the families to two or three fare families.

The goal of revenue management is to improve the revenues of the airline by setting limits on the maximum number of seats to be sold for each fare product, especially low revenue fare products. The airline can only offer a fixed, predetermined, number of seats. Some booking requests will generally have to be rejected due to a lack of capacity, and it is therefore important for the airline to ensure that as few high-revenue booking requests are rejected as possible. To do so, limits on the number of low-revenue products that should be sold are set. This ensures that a minimum number of seats is saved for the high willingness-to-pay passengers arriving late in the booking process.

Pricing and revenue management have typically been studied and optimized separately resulting in sub-optimal revenues and a larger workload for analysts who have to constantly go back and forth between the two disciplines. However, both pricing and revenue management are based on an analysis of booking patterns. Bookings are an indicator of underlying demand characteristics, such as demand elasticity, and are used for market segmentation for example. On the other hand, the analysis of the demand volume per fare product or group of fare products is the basis for setting booking limits. In turn, both pricing and revenue management processes affect the choice set available to a potential passenger during the booking procedure. By setting fares and travel constraints, pricing defines the global set of options that could be available to a passenger. However, booking limits may render one or more of these options unavailable at the time of booking and therefore restrict the actual choice set of a passenger.

Thus, a heretofore unaddressed need exists in the industry to address the aforementioned deficiencies and inadequacies.

### SUMMARY OF THE INVENTION

Embodiments of the present invention provide a system and method for jointly optimizing pricing and allocation. Briefly described, in architecture, one embodiment of the system, among others, can be implemented as follows. The system contains a memory and a processor. The processor is configured by the memory to perform the steps of: analyzing raw data to detruncate a demand for bookings and to determine how a change in fares affects a volume of booking requests; determining how booking limits censor the demand for bookings; determining revenues of all time frames for which seats are available; and determining fares and booking limits that maximize total revenues.

The present invention can also be viewed as providing methods for jointly optimizing pricing and allocation. In this regard, one embodiment of such a method, among others, can be broadly summarized by the following steps: analyzing raw data to detruncate a demand for bookings and to determine how a change in fares affects a volume of booking requests; determining how booking limits censor the demand for bookings; determining revenues of all time frames for which seats are available; and determining fares and booking limits that maximize total revenues.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating an example of fare families.

FIG. 2 is a schematic diagram illustrating a computer on which the present system and method may be provided.

FIG. 3 is a flowchart summarizing steps performed by the computer of FIG. 2 in the process of jointly optimizing pricing and seat allocation.

FIG. 4. Is a schematic diagram illustrating that there is no closed-form expression for the convolution of bounded Gaussian distributions.

FIG. 5 is a schematic diagram illustrating that a Gaussian probability density function is the sum of uniform probability density functions.

FIG. 6 is a schematic diagram exemplifying how the total number of accepted bookings, which is the total censored demand, is in most cases different from and lower than the underlying total demand.

FIG. 7 is a flow chart illustrating an example of a generalized methodology that may be used by the present system and method for finding the censored demand for all time frames.

FIG. 8 is a schematic diagram illustrating four regions representing different demand scenarios.

FIG. 9 is a schematic diagram illustrating a bounded uniform distribution.

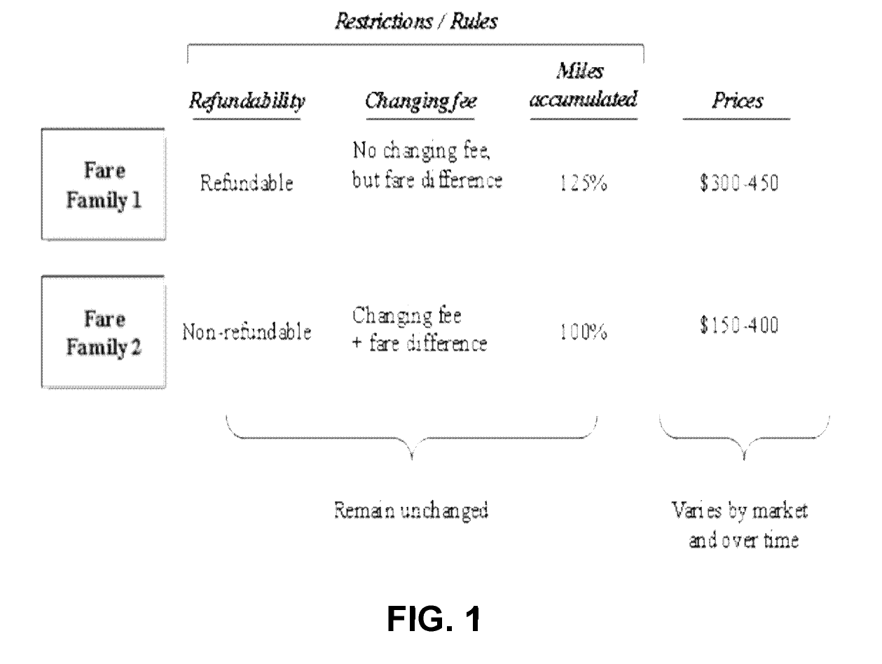

### DETAILED DESCRIPTION

The present system and method maximizes total revenues generated by the sale of seats during the k time periods by optimizing price points and seat allocation simultaneously. The present system and method jointly optimizes fares and booking limits for a seat allocation problem.

Demand is assumed to be a uniformly distributed random variable, with the mean being a linear function of the lowest fare. A geometrical analogy is used, although the present invention is not limited to this, to determine the transformed censored demand of each time frame and express the new objective revenue function.

The following description illustrates this joint pricing and seat allocation optimization model with reference to the airline industry, due to problem formulation being inspired by the growing use by airlines of “fare family” branding and pricing practices. As is the case with much of the research on pricing and revenue management (RM) developed for airlines, the present system and method clearly is applicable to mostly any other industry in which the same concepts of product differentiation can be applied, and where the price levels associated with each product can be changed dynamically over multiple periods of the selling process.

The present invention provides a fare structure that does not have to include advance purchase requirements. The fare families remain available throughout the entire selling period unless the flight sells out. To take into account the changing characteristics of the passengers, the present system and method divides the selling horizon into multiple subintervals, also called time frames and noted here TFi. Bookings start to be accepted at the beginning of the first time frame, TF1. The flight departs at the end of the last time frame, TFk. The prices of each fare family can be modified at the start of each time frame. These price points are decision variables. In accordance with the present description, xₜ and yₜ represent, for each TFt, the prices of Fare Family 1 and Fare Family 2, respectively. Fare Family 1 is assumed to be the family with fewer restrictions. It is therefore the more desirable fare product and as a result, xₜ≧yₜ.

In addition, in accordance with the present system and method, the airline can limit the total number of seats to be sold in each time frame, thereby protecting seats for demand in the subsequent time frames which could be charged higher fares. The booking limit for TFi is noted zᵢ. The present invention assumes that the total capacity is nested: unsold seats from the first time frames are available for booking in the subsequent time frames. The flight capacity C limits the total number of bookings that can be accepted over the course of the booking period. We have zₖ=C.

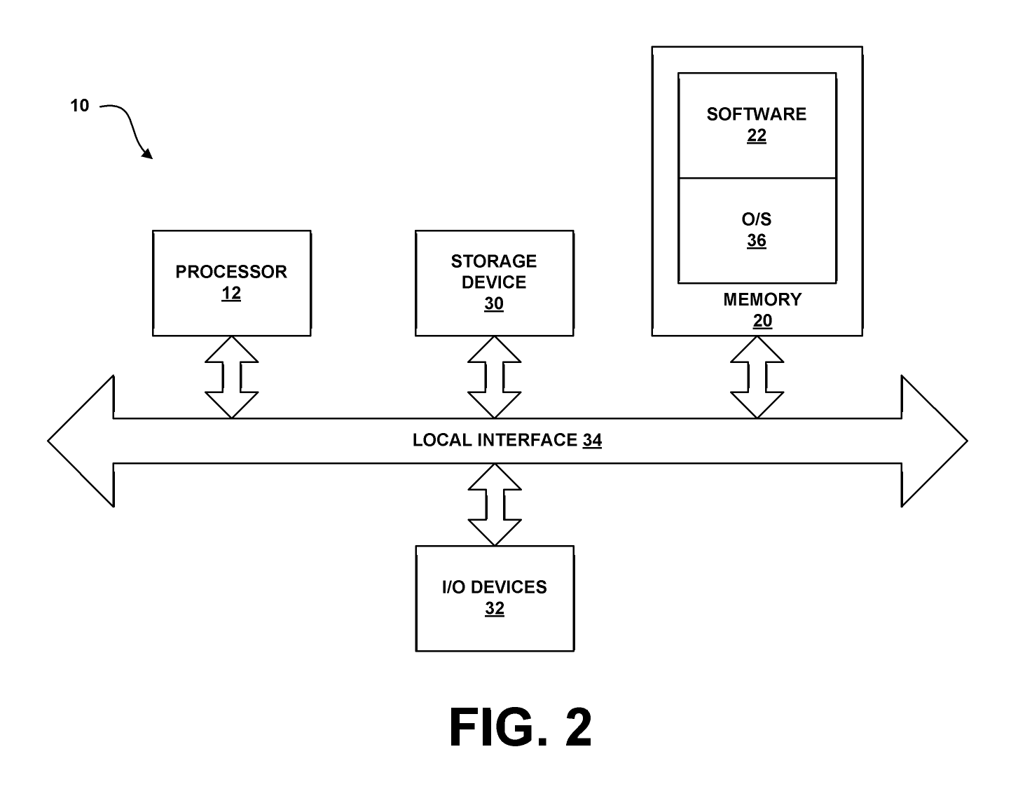

Functionality of the present system and method, as previously described, can be implemented in software, firmware, hardware, or a combination thereof. In a first exemplary embodiment, a portion of the system 10 is implemented in software, as an executable program, and is executed by a special or general-purpose digital computer, such as a personal computer, personal data assistant, smart phone, workstation, minicomputer, mainframe computer, server, or the like. FIG. 2 is a schematic diagram further illustrating a computer 10 on which the present system and method may be provided.

Generally, in terms of hardware architecture, as shown in FIG. 2, the computer 10 includes a processor 12, memory 20, storage device 30, and one or more input and/or output (I/O) devices 32 (or peripherals) that are communicatively coupled via a local interface 34. The local interface 34 can be, for example but not limited to, one or more buses or other wired or wireless connections, as is known in the art. The local interface 34 may have additional elements, which are omitted for simplicity, such as controllers, buffers (caches), drivers, repeaters, and receivers, to enable communications. Further, the local interface 34 may include address, control, and/or data connections to enable appropriate communications among the aforementioned components.

The processor 12 is a hardware device for executing software, particularly that stored in the memory 20. The processor 12 can be any custom made or commercially available processor, a central processing unit (CPU), an auxiliary processor among several processors associated with the communication device 10, a semiconductor based microprocessor (in the form of a microchip or chip set), a macroprocessor, or generally any device for executing software instructions.

The memory 20 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 20 may incorporate electronic, magnetic, optical, and/or other types of storage media. Note that the memory 20 can have a distributed architecture, where various components are situated remote from one another, but can be accessed by the processor 12.

The software 22 in the memory 20 may include one or more separate programs, each of which contains an ordered listing of executable instructions for implementing logical functions of the computer 10, as previously described. The software 22 in the memory 20 defines the computer 10 functionality in accordance with the present invention. In addition, although not required, it is possible for the memory 20 to contain an operating system (O/S) 36. The operating system 36 essentially controls the execution of computer programs and provides scheduling, input-output control, file and data management, memory management, and communication control and related services.

The computer 10 may be provided by a source program, executable program (object code), script, or any other entity containing a set of instructions to be performed. When a source program, then the program needs to be translated via a compiler, assembler, interpreter, or the like, which may or may not be included within the memory 20, so as to operate properly in connection with the O/S 36. Furthermore, the program can be written as (a) an object oriented programming language, which has classes of data and methods, or (b) a procedure programming language, which has routines, subroutines, and/or functions.

The I/O devices 32 may include input devices, for example but not limited to, a touch screen, a keyboard, mouse, scanner, microphone, or other input device. Furthermore, the I/O devices 32 may also include output devices, for example but not limited to, a display, or other output devices. The I/O devices 32 may further include devices that communicate via both inputs and outputs, for instance but not limited to, a modulator/demodulator (modem; for accessing another device, system, or network), a radio frequency (RF), wireless, or other transceiver, a telephonic interface, a bridge, a router, or other devices that function both as an input and an output.

When the computer 10 is in operation, the processor 12 is configured to execute the software 22 stored within the memory 20, to communicate data to and from the memory 20, and to generally control operations of the computer 10 pursuant to the software 22. The software 22 and the O/S 36, in whole or in part, but typically the latter, are read by the processor 12, perhaps buffered within the processor 12, and then executed.

When functionality of the present system is implemented in software, it should be noted that the functionality can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The functionality can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The storage device 30 of the computer 10 may be one of many different types of storage device, including a stationary storage device or portable storage device. As an example, the storage device 30 may be a magnetic tape, disk, flash memory, volatile memory, or a different storage device. In addition, the storage device may be a secure digital memory card or any other removable storage device 30.

In the formulation of traditional revenue management optimization problems, the prices of different fare products are known and fixed and are considered as input to the problem. The demand for the different fare products are forecasted independently, without accounting for any fare changes. In reality, however, fare prices do affect the demand and thus the revenues. The fare family structure can allow for quantifying the impact of a change in fares on the volume of the demand for that family, but also on the demand for other families as well.

Revenues of the airline can thus be further improved by, as performed in accordance with the present invention, modifying the formulation of the traditional seat inventory optimization problem and including prices as decision variables. To do so, fare family prices (e.g. xₜ and yₜ) are accounted for in a forecasting formulation.

The fare families may be assumed to be independent, for simplifying purposes. In this case, the demand for a fare family will be a function of its own fare only. It is however more reasonable to assume that there may be some interactions between the fare families, meaning that a change in the fares of one fare family may also affect the demand for the other fare families. In this case, fare families have to be forecasted altogether.

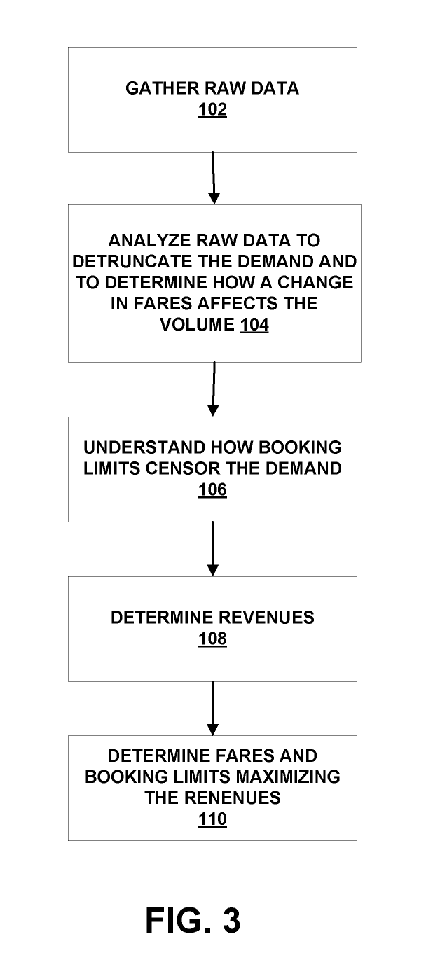

FIG. 3 is a flowchart summarizing steps performed by the computer 10 of FIG. 2 in the process of optimizing joint pricing and seat allocation. It should be noted that any process descriptions or blocks in flowcharts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As shown by block 102, raw data is gathered. The raw data may include historical information. Such historical information may include booking data and availability information, such as, but not limited to, what choices were available by the airline at the time of booking. Alternatively, surveys may be used to supplement historical data. In accordance with an alternative embodiment of the invention, surveys can also be used to understand how a passenger will pick one fare family over the other. For example, conjoint analysis can be helpful in understanding a passengers' tradeoff between restrictions and fares. The gathered raw data may be stored within the storage device 30 of the computer 10.

As shown by block 104, the computer 10 then analyzes the raw data to detruncate the demand for bookings and to determine how a change in fares affects the volume of bookings. Since one having ordinary skill in the art would know different ways to detruncate the demand, further description of how to detruncate the demand is not provided herein. The result of analyzing the raw data to detruncate, or uncensor, the demand and to determine how a change in fares affects volume of bookings is two equations, listed herein as equation 1 and equation 2, each of which is described in detail below.

Historical booking data and availability information are analyzed to detruncate the demand and estimate price elasticities and cross-price elasticities. As is known by those having ordinary skill in the art, price elasticity is a measure of how changing the price by one percent changes the increase in demand for product. In addition, cross-price elasticity is a measure of how changing the price of one product affects the demand of another product.

The best predictive model for the demand will vary from one market to the other; from one airline to the other. In accordance with the present system and method, the total demand volume for all fare families has to be estimated for each time frame TFt. In the present invention, the expected value of the total demand in TFt, noted μₜ, is expressed as a linear function of the lowest available price yₜ:

$${μ}_{t} ( {y}_{t} ) = {α}_{t} - {β}_{t} {y}_{t} \\ with {α}_{t} , {β}_{t} \geq 0 and {y }_{t} ∈ [ 0 , \frac{{α}_{t}}{{β}_{t}} ] . \qquad ( Eq . 1 )$$

Herein: yₜ is the price of fare product 2 in TFt; βₜ is the price-elasticity coefficient; and αₜ is a constant.

The expected value of the total demand ought to be a function of at least one of the fares. However, it does not have to be linear. It could, for example, be a function of the exponential value of the relative difference between the lowest fare and a reference point.

To quantify the interactions between fare families, different models can be tested. For exemplary purposes, one may try a simple cross-price elasticity formulation. In this case, the demand for Fare Family 1 in TFt, noted n_{1,t}, will, for example, be given by: n_{1,t}=aₜ+bₜyₜ−cₜxₜ, where bₜ,cₜ are the parameters for the cross-price elasticity and price elasticity. In accordance with the present invention, the interactions between the fares and the demand for each product are modeled with a more sophisticated multinomial choice model. The utility U_{i,t} associated to a Fare Family i in TFt is a function of its TFt's fare. The utility for Fare Family 1 and Fare Family 2 in TFt thus is U_{1,t}=a_{1,t}−cₜxₜ and U_{2,t}=a_{2,t}−bₜyₜ, respectively. The probability pₜ that a passenger chooses the less restricted fare family in TFt can be expressed as

$${p}_{t} ( {x}_{t} , {y}_{t} ) = \frac{{e}^{{U}_{1 , t}}}{{\sum }_{i} {e}^{{U}_{i , t}}} .$$

In other words, in the present case,

$${p}_{t} ( {x}_{t} , {y}_{t} ) = \frac{1}{1 + {e}^{{a}_{i} - {b}_{i} {y}_{i} + {c}_{i} {x}_{i}}} \qquad ( Eq . 2 )$$

with bₜ,cₜ≧0.
Herein: xₜ is the price of Fare Product 1 in TFt; and, pₜ is the probability that a random passenger chooses Fare Product 1 in TFt;

In accordance with the present system and method, the resulting demand for each fare family in TFt is a non-linear function of all the fare families' prices.

The demand is not deterministic. It is therefore necessary to use a probability distribution function to account for the variability observed in the historical data. The most commonly used probability distribution in revenue management is the Gaussian distribution. The present system and method does not use this probability density function. Instead, it is assumed that the total demand in each time frame is uniformly distributed.

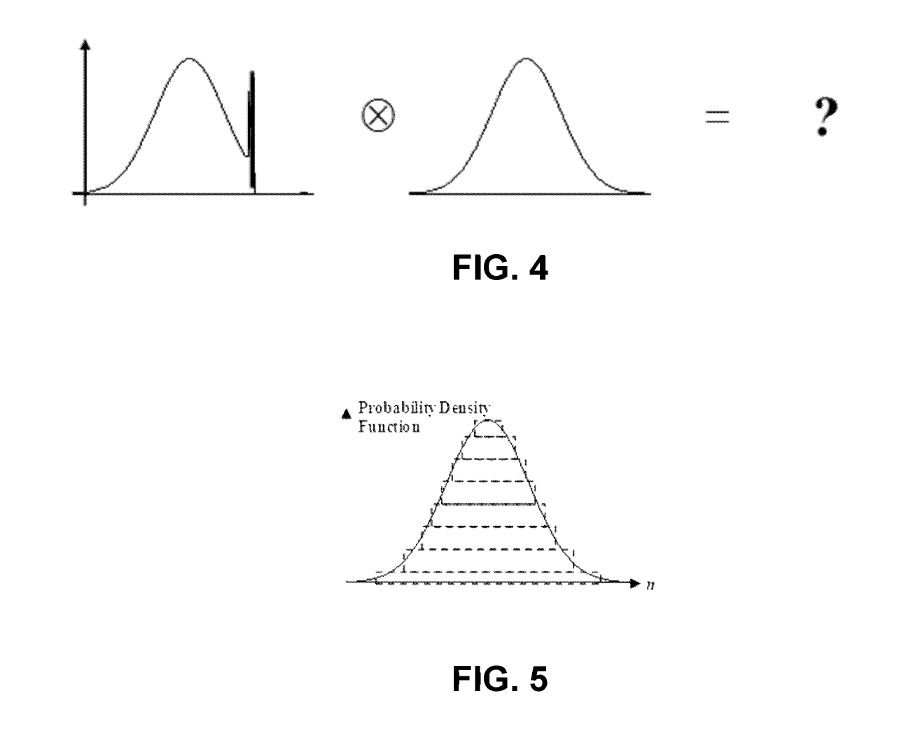

The probability density function of the sum of two independent random variables is the convolution product of their individual density functions. While it is known that the convolution of two unbounded Gaussian probability density functions is a simple Gaussian probability density function, there is no closed-form expression for the convolution of bounded Gaussian distributions, as illustrated by FIG. 4. In other words, because the booking limits or the flight capacity truncates the probability distribution function of the demand in the first time frame, the convolution product becomes extremely complex when the distributions are Gaussians. There is no closed form expression for the convolution of bounded Gamma distributions either. The uniform distribution, on the other hand, enables us to derive the probability density function of the sum of two bounded variables.

It is noted that all the work done with the uniform distribution can be used to model the Gaussian distribution. The Gaussian function can be seen as the limit of a sum of uniform functions, and the convolution product of two sums of functions is the sum of the convolution products of all possible pairs of functions. The schematic diagram of FIG. 5 illustrates how a Gaussian distribution is the sum of uniform distributions.

The uniform distribution does not put as much emphasis on the mean as the Gaussian distribution does. In reality, it might occur that a demand much lower or higher than the mean is more likely than the normal distribution predicts. Modeling the demand with the uniform distribution therefore protects the airline a bit more against lower revenues.

The total demand for all fare families may then be expressed as a stochastic additive function illustrated by equation 3.

n_{total,t}=μₜ(yₜ)+εₜ (Eq. 3)

In equation 3 the expectation of the total demand in TFt, denoted μₜ, can be a linear function of the lowest available booking price yₜ: μₜ(yₜ)=aₜ−βₜyₜ, with aₜ,βₜ≧0 and

$${y}_{t} ∈ [ 0 , \frac{{α}_{t}}{{β}_{t}} ] ,$$

as described in the previous section. In addition, the random variable εₜ is uniformly distributed εₜ˜U[−σₜ,σₜ].

The total number of bookings for a product at a given price would be equal to the total underlying demand for this product, noted n_{total,t}_{ₜ}, if it were not for some physical constraints. Indeed, the number of bookings is, for example, limited by the available inventory. The total capacity of a plane will cap the maximum number of bookings an airline may accept. In addition, booking limits will limit the quantity of seats that can be sold at a particular price point. The total number of accepted bookings is therefore a function of the underlying demand and the booking limits. Determining the expected number of accepted bookings, also called the censored demand, over the different time frames of the booking period is critical to the optimization problem.

Referring back to FIG. 3, as shown by block 106, the system estimates how booking limits censor the underlying demand and yields the censored demand

Once a booking limit is reached during the booking period, the fares of the fare families change, thus affecting the behavior of the demand. The average number of accepted bookings, also called “censored” demand, is displaced. We note n̅_{accepted,t} the average total number of accepted bookings in TFt.

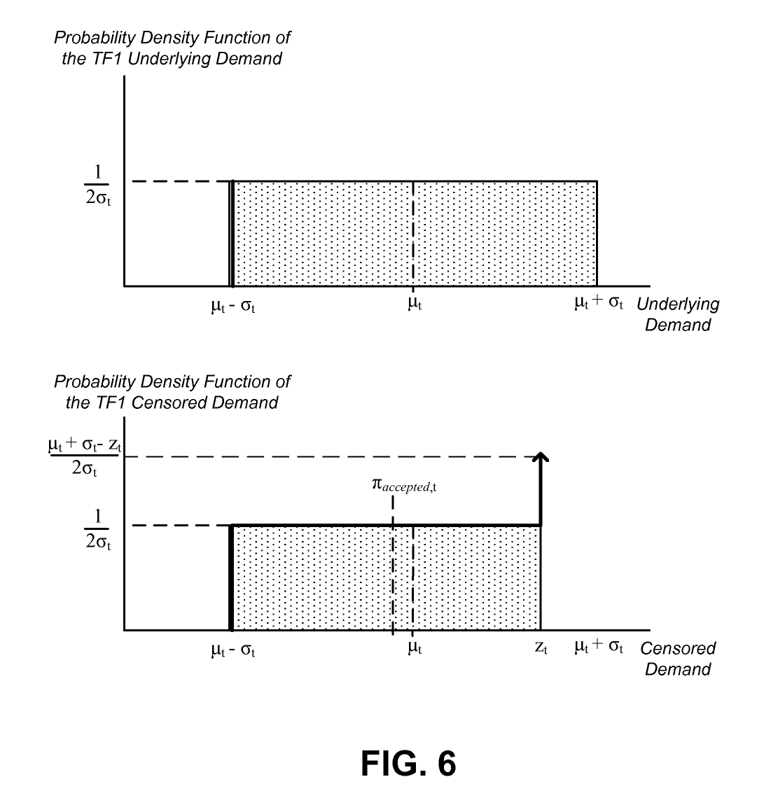

Again, it is important to note the difference between the underlying demand and the actually observed number of bookings or censored demand. The underlying demand is the demand that would be observed if the airline could accept all the booking requests it received. However, in reality, they are physical constraints that bound the total number of bookings that can be accepted. Once the flight capacity or the booking limits are reached, the airline has to reject booking requests. Therefore, the total number of accepted bookings, which is the total censored demand, is in most cases different from and lower than the underlying total demand. This is exemplified by the schematic diagram of FIG. 6.

The revenues generated by the sale of the fare families depend on the number of accepted bookings. The expected revenues are thus a function of the expected censored demand n̅_{accepted,t}.

The number of bookings accepted in a time frame will affect the number of bookings that can be accepted in all the remaining time frames, as the inventory is nested. Any unsold seats at the end of a time frame are available for booking in the following time frames.

It is impossible to find the closed form expression of the censored demands for the later time frames of the booking period if the assumed probability distribution is Gaussian. However, if it is assumed that the demand follows a uniform distribution, a recurring method can allow for determining the censored demands for all time frames or a subset of time frames. It should be noted that, herein the phrase “all time frames” may refer to every time frame available, or every time frame within a subset of time frames.

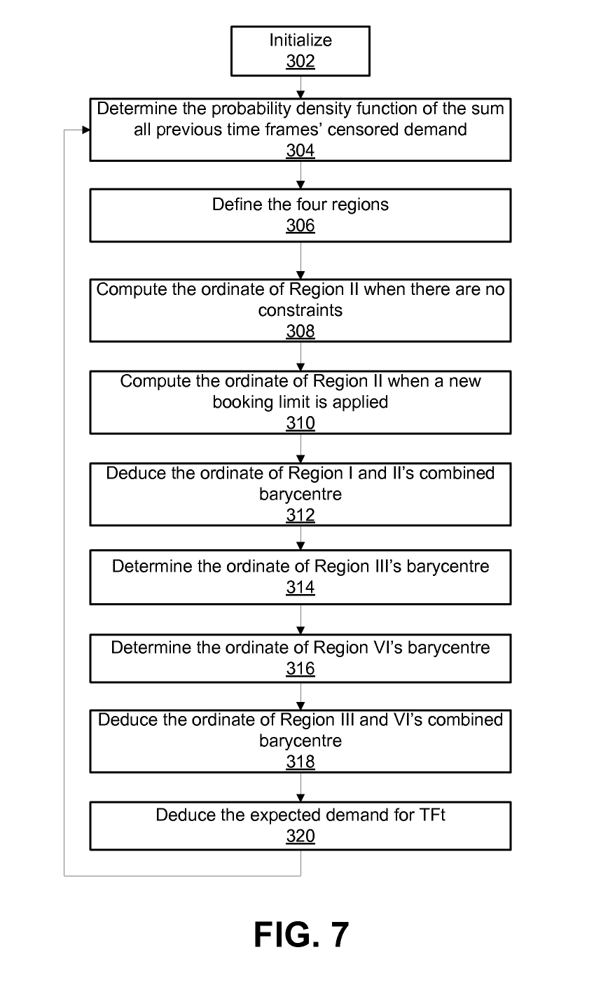

An example of a generalized methodology that may be used by the present system and method for finding the censored demand for all time frames is detailed below, and illustrated by the flowchart of FIG. 7. It is noted that the present system and method determines the cascading impact of prices and booking limits on subsequent time frames. Specifically, the present invention divides the booking horizon into multiple time frames and determines the impact of decisions made during the first time frame on all other time frames within the booking horizon. In addition, the present invention models the impact of the price change and the booking limit change in all time frames so as to solve for an optimal solution having the best revenue.

As shown by block 302, the present system is initialized to define a probability density function ƒ₁ of the censored total demand in the first time interval (TF1). To deduce the expected censored total demand n̅_{accepted,1}, we have the following:

$${\overline{n}}_{accepted , 1} = \{ \begin{matrix}{μ}_{1} , & if {z}_{1} \geq {μ}_{1} + {σ}_{1} \\ \frac{{z}_{1} + {μ}_{1}}{2} - \frac{{( {μ}_{1} - {z}_{1} )}^{2}}{4 {σ}_{1}} - \frac{{σ}_{1}}{4} , & if {z}_{1} ∈ [ {μ}_{1} - {σ}_{1} , {μ}_{1} + {σ}_{1} ] \\ {z}_{1} , & if {z}_{1} \leq {μ}_{1} - {σ}_{1}\end{matrix}$$

The maximum number of bookings that can be accepted in a time frame depends on the remaining capacity at the end of the previous time frame. The challenge then consists in expressing the censored demand for each of the k time frames, given the demand and booking limits of all the prior time frames. As shown by block 304, for TFt, the system determines the probability density function θₜ₋₁ of the sum

$${\sum }_{i = 1}^{t - 1} {\overline{n}}_{accepted , i}$$

of all the previous time frames' censored total demand. If t=2, then ƒ₁ is simply the function found in the first step of the initialization process. If t≧3, then:

$${f}_{t - 1} ( x ) = \{ \begin{matrix}{f}_{t - 2} * {u}_{t - 1} ( x ) & if x ∈ [ {\sum }_{i = 1}^{t - 1} {μ}_{i} , {z}_{t - 1} [ , \\ {\int }_{{z}_{k - 1}}^{∞} {f}_{t - 2} * {u}_{t - 1} ( t ) d t & if x = {z}_{t - 1} , \\ 0 & otherwise .\end{matrix}$$

Herein, the function μₜ is the probability density function of the total underlying demand in TFt: it is a uniform distribution U[μₜ(yₜ)−σₜ,μₜ(yₜ)+σₜ].

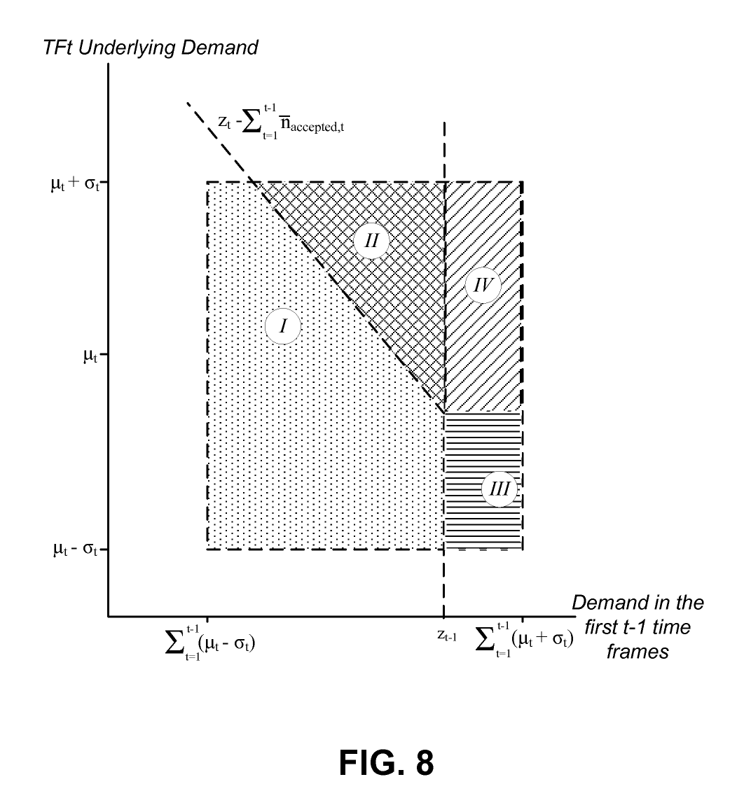

The region of possible values for the underlying demand in two subsequent time frames can be divided into four smaller regions, based on the value for the booking constraints zₜ and the total capacity C. These four possible regions are shown in block 306. Each region represents a demand scenario. These regions are illustrated by the graph of FIG. 8. The x-axis in FIG. 8 is the sum of the previous time frames' censored demand,

$${\sum }_{i = 1}^{t - 1} {\overline{n}}_{accepted , i} .$$

The y-axis in FIG. 8 represents the underlying demand for the time frame of interest, TFt. In addition, zₜ₋₁ is the booking limit. The two constraints considered are the booking limits zₜ₋₁ and zₜ.

Referring to FIG. 8, Region I is not affected by either constraint. In Region II, the sum of the censored demands from TF1 to TFt−1 is lower than the booking limit zₜ₋₁. This constraint is not enforced. The other constraint, zₜ, nonetheless, applies to the sum of bookings from TF1 to TFt. Further, in Region III, the booking limit zₜ₋₁ applies to the sum of the accepted bookings from TF1 to TFt−1: the sum is censored and only zₜ₋₁ bookings are accepted. The sum of the censored demand from TF1 to TFt is, however, lower than zₜ. The TFt demand is therefore not capped. Still further, in Region IV, both constraints apply: the number of accepted bookings from the first t−1 time frames is equal to zₜ₋₁ and the bookings in the t^{th} time frame are censored to zₜ−zₜ₋₁.

For each of one these four regions, we need to find the ordinate of the barycentre, and then deduce n̅_{accepted,t}. As shown by block 308, the system then computes the ordinate of Region II's barycentre when there are no constraints (booking limits) applied.

$$g ( x ) = \{ \begin{matrix}{\int }_{{z}_{k - 1}}^{∞} {f}_{t - 1} ( y ) d y & if x ∈ [ {z}_{t} - {μ}_{t} - {σ}_{t} ; {z}_{t - 1} [ , \\ 0 & otherwise .\end{matrix}$$

To deduce the area of Region II: Area=∫_{z}_{ₜ}_{-z}_{_{t−1}}ⁿ^{ₜ}^{σ}^{ₜ}g(y)dy. We then normalize the function g and note the new function G. Then, to obtain the coordinate of the region's barycentre: Y_{no constra int s}=∫_{z}_{ₜ}_{-z}_{_{t−1}}ⁿ^{ₜ}^{σ}^{ₜ}yG(y)dy.

As shown by block 310, the system then computes the ordinate of Region II's barycenter when a new booking limit (the constraint zₖ) is applied.

$$h ( x ) = \{ \begin{matrix}( x - {z}_{k} ) {f}_{t - 1} ( x ) & if x ∈ [ {z}_{t} - {μ}_{t} - {σ}_{t} ; {z}_{t - 1} [ , \\ 0 & otherwise .\end{matrix}$$

This function is normalized and the new function H is noted. The system then deduces the coordinate of the region's barycentre Y_{constra int s}=∫_{z}_{ₜ}_{-z}_{_{t−1}}ⁿ^{ₜ}^{σ}^{ₜ}yH(y)dy.

As shown by block 312, the system then deduces the ordinate of Region I and II's combined barycenter:

$${Y}_{I , II} = {μ}_{t} + ( {Y}_{contraints} - {Y}_{no constraints} ) \frac{Area}{[ {z}_{t - 1} - {\sum }_{i = 1}^{t} ( {μ}_{i} - {σ}_{i} ) ] 2 {σ}_{t}}$$

As shown by block 314, the system then determines the ordinate (Y_{III}) of Region III's barycenter by using the following equation.

$${Y}_{III} = \frac{1}{2} ( {z}_{t} - {z}_{t - 1} - {\sum }_{i = 1}^{t} ( {μ}_{i} - {σ}_{i} ) ) .$$

Herein, the length of Region III is

$$( {z}_{t} - {z}_{t - 1} - {\sum }_{i = 1}^{t} ( {μ}_{i} - {σ}_{i} ) ) .$$

As shown by block 316, the system then determines the ordinate of Region IV's barycenter. In this region, the zₜ booking limit applies. Therefore, all the TFk bookings are capped to zₜ−zₜ₋₁, and Y_{IV}=zₜ−zₜ₋₁. The length of this region is

$$2 {σ}_{t} - [ {z}_{t} - {z}_{t - 1} - {\sum }_{i = 1}^{t} ( {μ}_{i} - {σ}_{i} ) ] .$$

As shown by block 318, the system then deduces the ordinate of Regions III and IV's combined barycenter. To do this, the following equation is used.

$${Y}_{III , IV} = {Y}_{IV} \frac{2 {σ}_{t} - [ {z}_{t} - {z}_{t - 1} - {\sum }_{i = 1}^{t} ( {μ}_{i} - {σ}_{i} ) ]}{2 {σ}_{t}} + {Y}_{III} \frac{{z}_{t} - {z}_{t - 1} - {\sum }_{i = 1}^{t} ( {μ}_{i} - {σ}_{i} )}{2 {σ}_{t}}$$

$${Y}_{III , IV} = {Y}_{IV} \frac{2 {σ}_{t} - [ {z}_{t} - {z}_{t - 1} - ( {μ}_{t} - {σ}_{t} ) ]}{2 {σ}_{t}} + {Y}_{III} \frac{{z}_{t} - {z}_{t - 1} - {μ}_{i} - {σ}_{i}}{2 {σ}_{t}}$$

Finally, as shown by block 320, the system deduces the expected censored demand for TFt, which according to the equations, is deducing n̅_{accepted,t} from Y_{I,II} and Y_{III,IV}. As,

2σₜ₋₁ n̅_{accepted,t}=Y_{I,II}(zₜ₋₁−μₜ₋₁+σₜ₋₁)+Y_{III,IV}(μₜ₋₁+σₜ₋₁−zₜ₋₁)

The expected total revenues are a function of the fares and the booking limits:

$${\overline{R}}_{total} = {\sum }_{t = 1}^{k} {\overline{n}}_{accepted , t} \cdot [ {p}_{t} {x}_{t} + ( 1 - {p}_{t} ) {y}_{t} ] .$$

The combined impact of both the prices and the booking limits on the accepted number of bookings is thus modeled.

The recurrence can be easily done for a few time frames (4-5 time frames). However, the probability density function ƒᵢ becomes more complex with each iteration, resulting in a possible processor speed drain. The initial advantage presented by the simplicity of the uniform distribution disappears as we go from one truncated convolution product to another. Accordingly, the analysis of Region II, blocks 308 and 310 of the recurrence, becomes fairly complicated. The resulting ordinate of Regions I and II's combined barycentre, grows larger with each iteration, involving an increasingly large number of variables. Therefore, the approach illustrated by the above example is very quickly impractical, especially since airlines typically divide the booking period into more than 20 time frames. As a result of the abovementioned impracticality, in accordance with the present invention, a heuristics is applied to the multiple-time frame joint pricing and seat allocation optimization problem, as is described in detail below.

It is noted that the expression of the ordinate of Regions I and II's combined barycentre is very complex. The main difficulty does arise from the increasingly complex probability density function ƒₜ of the sum of the censored demands (block 304 of the recurrence, previously described). The present invention introduces a heuristic, which is used by the present system and method to simplify the joint pricing and seat allocation optimization problem and solve for it efficiently (simplifying block 304).

Much of the difficulty arises from the increasing complexity of the function ƒₜ₋₁ the probability density function the sum of the censored demands

$${\sum }_{i = 1}^{t - 1} {\overline{n}}_{accepted , i}$$

accepted between TF1 and TFt−1. As previously mentioned with regard to block 304, the function is the convolution product of the previous time frame's ƒₜ₋₂ and a uniform distribution. The complexity of the convolution product increases with the index of the time frame, and reflects in all the following steps of the recurrence. Therefore, the heuristic simplifies this function. The heuristic, however, keeps the nested structure of the demand.

The convolution product can be directly replaced by a new bounded uniform distribution:

$$∀ t \geq 2 , {f}_{t - 1}^{′} ( x ) = \{ \begin{matrix}\frac{1}{{\prod }_{i = 1}^{t - 1} {σ}_{i}} & if x ∈ [ {\sum }_{i = 1}^{t - 1} ( {μ}_{i} - {σ}_{i} ) , {z}_{t - 1} [ , \\ \frac{{\sum }_{i = 1}^{t - 1} ( {μ}_{i} + {σ}_{i} ) - {z}_{t - 1}}{{\prod }_{i = 1}^{t - 1} {σ}_{i}} & if x = {z}_{t - 1} , \\ 0 & otherwise .\end{matrix}$$

This transformation greatly simplifies the recurrence previously mentioned. The probability density function ƒ′ₜ₋₁ of the sum of the censored demands

$${\sum }_{i = 1}^{t - 1} {\overline{n}}_{accepted , i}$$

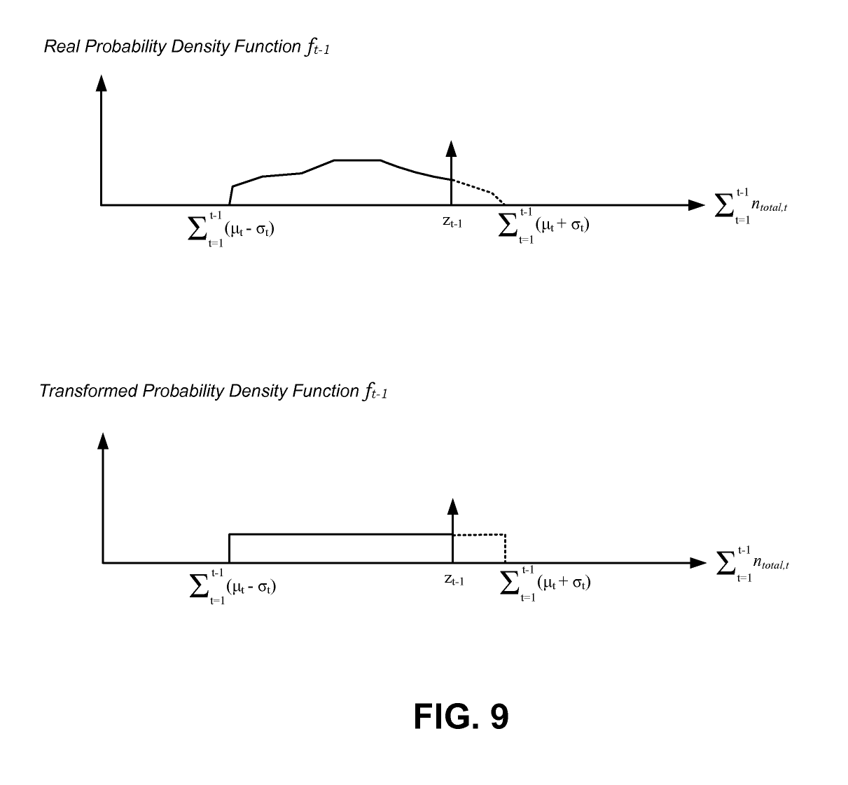

always has the same form. It is a bounded uniform distribution, as shown in FIG. 9. All the functions ƒ′ₜ₋₁ have the form of the probability density function ƒ₂ of the censored total demand in TF2. As a consequence, the censored demands for all time frames TFt with t>1 all have the same form: ∀t≧2,

$${\overline{n}}_{accepted , t} = [ {μ}_{t} - \frac{{( {μ}_{t} + {σ}_{t} - {z}_{t} + {z}_{t - 1} )}^{3}}{12 {σ}_{t} ( \begin{matrix}{z}_{t - 1} - {μ}_{equi , t - 1} + \\ {σ}_{equi , t - 1}\end{matrix} )} ] \frac{( \begin{matrix}{z}_{t - 1} - {μ}_{equi , t - 1} + \\ {σ}_{equi , t - 1}\end{matrix} )}{2 {σ}_{equi , t - 1}} + [ \begin{matrix}\frac{{z}_{t} - {z}_{t - 1} + {μ}_{t}}{2} - \\ \frac{{( {μ}_{t} - {z}_{t} + {z}_{t - 1} )}^{2}}{4 {σ}_{t}} - \frac{{σ}_{t}}{4}\end{matrix} ] \cdot \frac{( \begin{matrix}{μ}_{equi , t - 1} + \\ {σ}_{equi , t - 1} - {z}_{t - 1}\end{matrix} )}{2 {σ}_{equi , t - 1}}$$

$$where$$

$$\{ \begin{matrix}{μ}_{equi , t - 1} = {\sum }_{i = 1}^{t - 1} {μ}_{i} \\ {σ}_{equi , t - 1} = {\sum }_{i = 1}^{t - 1} {σ}_{i} .\end{matrix}$$

The first time frame remains the same:

$$for t = 1 , {\overline{n}}_{accepted , 1} = \frac{{z}_{1} + {μ}_{1}}{2} - \frac{{( {μ}_{1} - {z}_{1} )}^{2}}{4 {σ}_{1}} - \frac{{σ}_{1}}{4} ,$$

Returning to FIG. 3, as shown by block 108, revenues are then determined. The expected revenues for all time frames are given by the expression:

$${\overline{R}}_{total} = {\sum }_{i = 1}^{k} {\overline{n}}_{accepted , i} [ {p}_{i} {x}_{i} + ( 1 - {p}_{i} ) {y}_{i} ] ,$$

which is the total accepted demand (censored demand) multiplied by the weighted average based on the demand for the two prices (average weighted price). Herein, xᵢ is the price of Fare Product 1, yᵢ is the price of Fare Product 2, pᵢ is the probability that a passenger will choose the higher Fare Product 1, (1−pᵢ) is the probability that a passenger will choose the lower Fare Product 2, and i is an indication of the present timeframe being considered.

As shown by block 110, the present system and method then uses a standard non-linear constrained maximization technique, such as, but not limited to, the Powell's algorithm, to solve for the fares and booking limits, maximizing the total revenues. As would be appreciated by one having ordinary skill in the art, this is a constrained optimization problem, and one having ordinary skill in the art would know how to use a constrained optimization problem to solve for the fares and booking limits.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

We claim:

1. A system for jointly optimizing pricing and allocation, comprising:
a memory; and
a processor configured by the memory to perform the steps of:
analyzing raw data to detruncate a demand for bookings and to determine how a change in fares affects a volume of bookings;
determining how booking limits censor the demand for bookings;
determining revenues of at least a subset of all time frames for which bookings are available; and
determining fares and booking limits, while maximizing total revenues.

2. The system of claim 1, wherein the total demand is expressed as a linear function of the lowest available booking price.

3. The system of claim 2, wherein the total demand is a function of an exponential value of a relative difference between a lowest fare and a reference point.

4. The system of claim 2, wherein the total demand is a function of the booking price.

5. The system of claim 1, wherein the raw data includes historical data.

6. The system of claim 1, wherein analyzing the raw data further comprises the step of estimating price elasticities and cross-price elasticities.

7. The system of claim 1, wherein the step of determining how booking limits censor the demand further comprises the step of finding a censored demand for all time frames in which seats are available.

8. The system of claim 1, wherein the step of determining how booking limits censor the demand further comprises the step of dividing a booking horizon into multiple time frames and determining the impact of booking limits and prices of early timeframe on subsequent timeframes within the booking horizon.

9. The system of claim 1, wherein the step of determining revenues of all timeslots for which bookings are available, further comprises the step of determining expected revenues for all time frames by use of the expression
$${\overline{R}}_{total} = {\sum }_{i = 1}^{k} {\overline{n}}_{accepted , i} [ {p}_{i} {x}_{i} + ( 1 - {p}_{i} ) {y}_{i} ] ,$$
which is a total accepted demand (censored demand) multiplied by a weighted average based on the demand for two prices (average weighted price), wherein xᵢ is the price of Fare Product 1, yᵢ is the price of Fare Product 2, pᵢ is the probability that a passenger will choose the higher Fare Product 1, (1−pᵢ) is the probability that a passenger will choose the lower Fare Product 2, and i is an indication of the present timeframe being considered.

10. A method for jointly optimizing pricing and allocation, comprising the steps of:
analyzing raw data to detruncate a demand for bookings and to determine how a change in fares affects a volume of bookings;
determining how booking limits censor the demand for bookings;
determining revenues of at least a subset of all time frames for which bookings are available; and
determining fares and booking limits, while maximizing total revenues.

11. The method of claim 10, wherein the total demand is expressed as a linear function of the lowest available booking price.

12. The method of claim 11, wherein the total demand is a function of an exponential value of a relative difference between a lowest fare and a reference point.

13. The method of claim 11, wherein the total demand is a function of the booking price.

14. The method of claim 10, wherein the raw data includes historical data.

15. The method of claim 10, wherein analyzing the raw data further comprises the step of estimating price elasticities and cross-price elasticities.

16. The method of claim 10, wherein the step of determining how booking limits censor the demand further comprises the step of finding a censored demand for all time frames in which seats are available.

17. The method of claim 10, wherein the step of determining how booking limits censor the demand further comprises the step of dividing a booking horizon into multiple time frames and determining the impact of booking limits and prices of early timeframe on subsequent timeframes within the booking horizon.

18. The method of claim 1, wherein the step of determining revenues of all timeslots for which bookings are available, further comprises the step of determining expected revenues for all time frames by use of the expression
$${\overline{R}}_{total} = {\sum }_{i = 1}^{k} {\overline{n}}_{accepted , i} [ {p}_{i} {x}_{i} + ( 1 - {p}_{i} ) {y}_{i} ] ,$$
which is a total accepted demand (censored demand) multiplied by a weighted average based on the demand for two prices (average weighted price), wherein xᵢ is the price of Fare Product 1, yᵢ is the price of Fare Product 2, pᵢ is the probability that a passenger will choose the higher Fare Product 1, (1−pᵢ) is the probability that a passenger will choose the lower Fare Product 2, and i is an indication of the present timeframe being considered.
